(19) United States
(12) Patent Application Publication
(10) Pub. No.: US 2015/0088623 A1
(43) Pub. Date: Mar. 26, 2015

(54) METHOD AND APPARATUS FOR IDENTIFYING HIGH PERFORMING AD PLACEMENT PAGES

(71) Applicant: Google Inc., Mountain View, CA (US)

(72) Inventor: Alok Goel, Bangalore (IN)

(73) Assignee: Google Inc., Mountain View, CA (US)

(21) Appl. No.: 13/651,933

(22) Filed: Oct. 15, 2012

(51) Int. Cl. G06Q 30/02

(52) U.S. Cl. 705/14.6

(57) ABSTRACT

A non-transitory computer-readable medium that stores instructions executable by one or more processors to perform a method for identifying a high performing website for placement of an advertisement is provided. The non-transitory computer-readable medium includes, but is not limited to, instructions for compiling a list of N number of existing high performing websites for which a preselected advertisement performs well, instructions for compiling a list of websites which appear together along with any existing high performing website in a search result, instructions for flagging any website which appears together along with an existing high performing website in a statistically significant number of search results as a statistically significant website, and instructions for determining a co-occurrence rate for each statistically significant website and each existing high performing website.

### BACKGROUND OF THE INVENTION

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to an interne search engine, relevant to content in a document requested by the user, etc.). Query keyword targeting has been used by interne search engines to deliver relevant ads. For example, the Advertisement Words advertising system by Google Inc. of Mountain View, Calif., delivers ads targeted to keywords from search queries. Similarly, content targeted advertisement delivery systems have been proposed.

As can be appreciated from the foregoing, serving ads relevant to concepts of text in a text is useful because such ads presumably concern a current user interest. Consequently, such content-targeted advertising has become increasingly popular. However, such advertising systems still have room for improvement.

The success of the content-targeted advertising networks, such as a Google AdSense program for example, relies on three important constituents—advertisers, website publishers (referred to below as “Web publishers”), and end users. Many advertisers want be assured that the websites where their ads are displayed are high performing websites which have high performing advertisement placement pages. High performing websites are typically websites of a high quality, websites that will generate a positive return on investment (ROI), and websites that will generally not cause any controversy for the advertiser. Web publishers need to continue to attract end users through relevant and high quality content. Last, but not least, end users generally want to visit websites that provide a good experience. Further, end users generally select only those ads that are relevant to the context of a website, or webpage within that website, and that help them find a product or service that meets their needs. A high-quality advertising network is thus critical to ensure that a virtuous cycle is created that helps expands the advertising network by attracting new publishers, advertisers and end users.

Advertisers often run their marketing campaigns on several different pages across the Internet. Advertisers may do so with help of the advertising network, such as the Google Ad Sense program, or by directly negotiating advertising contracts with websites. Advertisers may spend a significant amount of time identifying high performing websites where an advertising campaign may lead to a positive return on investment. After several iterations, an advertiser may often end up getting few high performing websites from the many websites that carry ads from an advertising campaign for that advertiser.

Accordingly, there is a need for a method and apparatus for automatically, and more reliably, identifying and expanding the number of high performing websites for a particular advertising campaign.

### SUMMARY

The present invention is defined by the following claims, and nothing in this section should be taken as a limitation on those claims.

In one aspect, a method for identifying a high performing website for placement of an advertisement is provided. The method includes, but is not limited to, compiling a list of N number of existing high performing websites for which a preselected advertisement performs well, reviewing an interne search engine's search logs which contain search results, compiling a list of websites which appear together along with any existing high performing website in a search result, and flagging any website which appears together along with an existing high performing website in a statistically significant number of search results as a statistically significant website. The method also includes, but is not limited to, determining a co-occurrence rate for each statistically significant website and each existing high performing website. If the co-occurrence rate for a statistically significant website is equal to or greater than a predetermined percentage of existing high performing websites, then the statistically significant website is designated as a potential high performing website.

In one aspect a method for identifying a high performing website for placement of an advertisement is provided. The method includes, but is not limited to, compiling a list of N number of existing high performing websites for which a preselected advertisement performs well, generating a list of prominent keywords from each high performing website, performing a search query for each prominent keyword generated using an interne search engine in order to generate a search result from each prominent keyword, compiling a list of websites which appear together along with any existing high performing website in each search result, and flagging any website which appears together along with an existing high performing website in a statistically significant number of search results as a statistically significant website. The method also includes, but is not limited to, determining a co-occurrence rate for each statistically significant website and each existing high performing website. If the co-occurrence rate for a statistically significant website is equal to or greater than a predetermined percentage of existing high performing websites, then the statistically significant website is designated as a potential high performing website.

In one aspect, a non-transitory computer-readable medium that stores instructions executable by one or more processors to perform a method for identifying a high performing website for placement of an advertisement is provided. The non-transitory computer-readable medium includes, but is not limited to, instructions for compiling a list of N number of existing high performing websites for which a preselected advertisement performs well, instructions for compiling a list of websites which appear together along with any existing high performing website in a search result, instructions for flagging any website which appears together along with an existing high performing website in a statistically significant number of search results as a statistically significant website, and instructions for determining a co-occurrence rate for each statistically significant website and each existing high performing website. If the co-occurrence rate for a statistically significant website is equal to or greater than a predetermined percentage of existing high performing websites, then the statistically significant website is designated as a potential high performing website.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an exemplary diagram of a high performing website for placement of an advertisement in accordance with some embodiments.

FIG. 2 is an exemplary diagram of first search results that may be used in identifying a high performing website for placement of an advertisement in accordance with some embodiments.

FIG. 3 is an exemplary diagram of second search results that may be used in identifying a high performing website for placement of an advertisement in accordance with some embodiments.

FIG. 4 is a flowchart of a method for identifying a high performing website for placement of an advertisement in accordance with some embodiments.

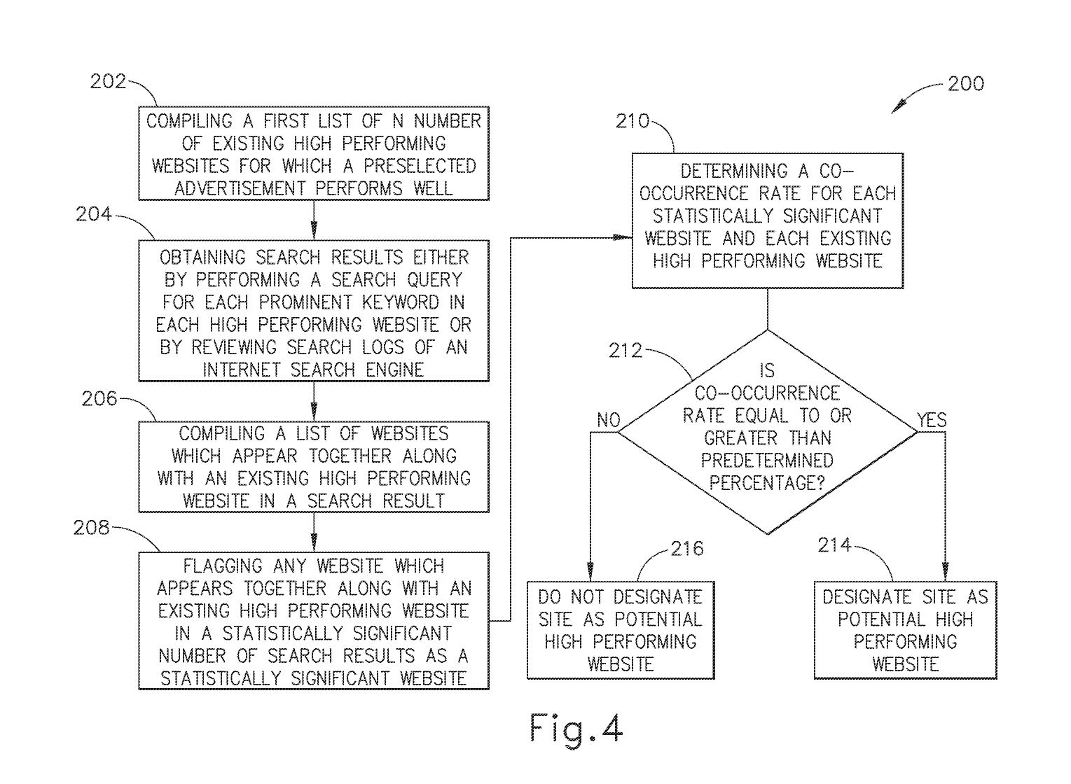

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Methods and devices consistent with the present invention overcome the disadvantages of conventional methods by providing method for identifying a high performing website which identifies statistically significant websites using search results and then, based on a co-occurrence rate for each statistically significant website an each high performing website, determines if the statistically significant website is a potential high performing website. In this manner, a more reliable and automated method for identifying high performing websites may be provided.

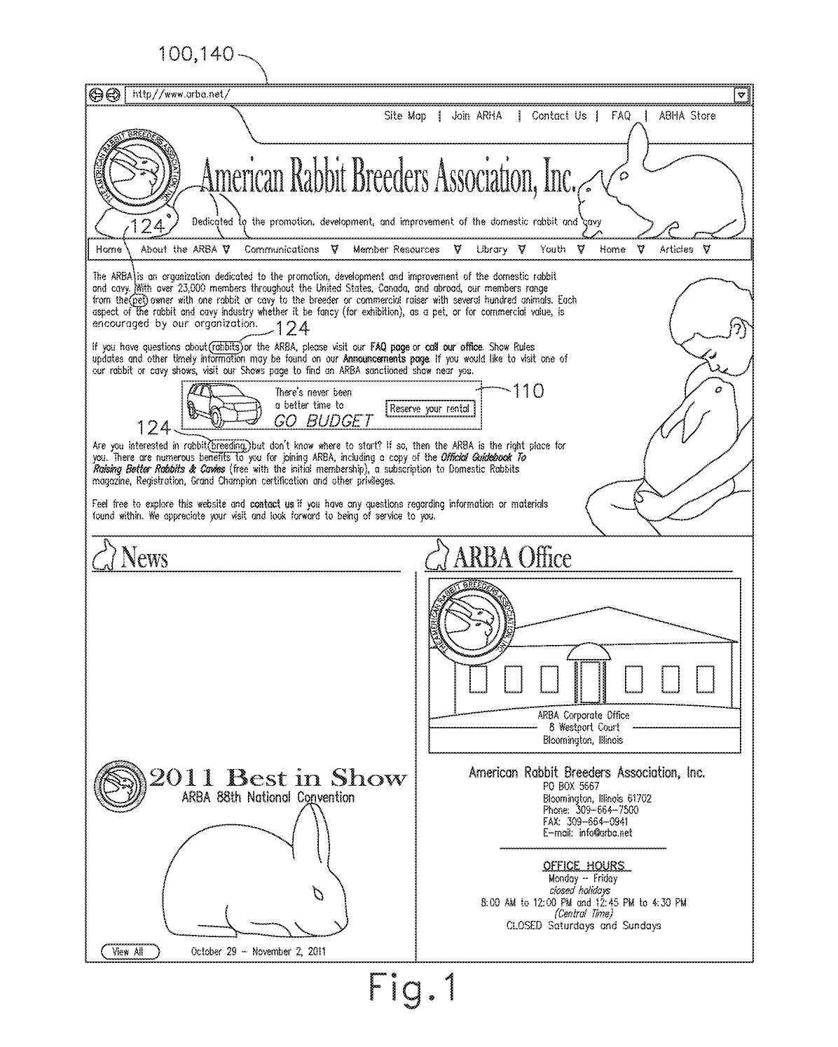

With reference to FIG. 1, an exemplary diagram of a high performing website 100 for placement of an advertisement 110 in accordance with some embodiments is shown. Advertisers which place advertisements 110 on websites 140 prefer that the websites 140 upon which their advertisements 110 are displayed are high performing websites 100. High performing websites 100 are websites which have been deemed to have high performing advertisement placement webpages. High performing websites 100 are typically websites of a high quality, websites that will generate a positive return on investment (ROI), and websites that will generally not cause any controversy for the advertiser. Preferably, the advertiser, another user, or a computer, screens various websites 140 upon which a preselected advertisement 110 or advertisements are displayed, preferably all from the same advertisement campaign, and then determines which websites 140 provide the best results for the preselected advertisement 110 and then designates those websites 140 to be high performing websites 100. Preferably, at least one, and preferably more than one, and most preferably N number of high performing websites 140 are designated to be high performing websites 100. Preferably, N is at least 5, and more preferably at least 10, and more preferably at least 20, and more preferably at least 50. Designating a website 140 to be a high performing website 100 may be done objectively, such as by providing a set of rules, or subjectively.

Preferably, a high performing website 100 has a lower cost per action than a predetermined amount. The cost per action of a high performing website 100 is defined as the amount of advertising dollars spent for each time a consumer selects an advertisement 110 and performs an “action” for that advertisement 110 is attempting to try and get the user to perform, such as, purchasing a product or service, performing a survey, signing up for a newsletter, expressing intent to know more details about the product/services of the company, and spending more than X number of minutes on website interacting with content. Preferably, a high performing website 100 has a low cost per action, and preferably a cost per action which is lower than a predetermined amount of money.

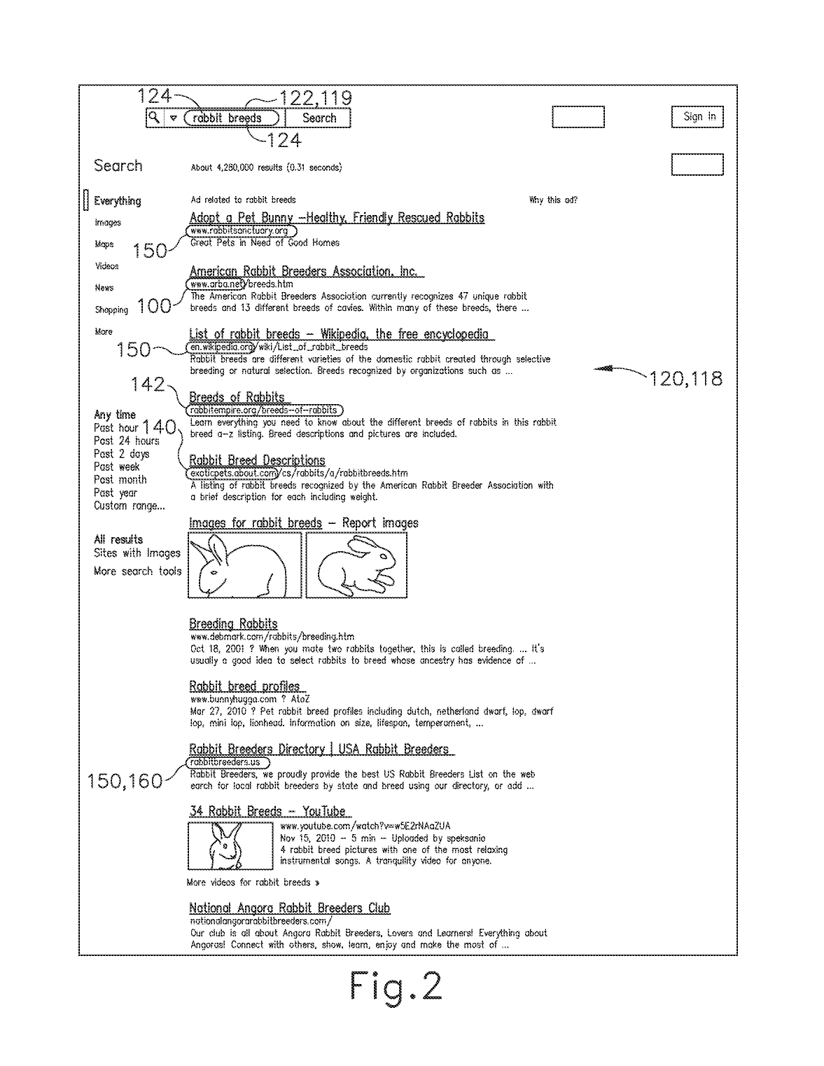

With reference to FIG. 2, a method 200 for identifying a high performing website 100 for placement of an advertisement 110. Preferably, the advertisement 110 is from an advertiser, such as a person or company, and preferably is part of an advertisement campaign. The method 200 starts at block 202 by first compiling a list of N number of existing high performing websites 140 for which a preselected advertisement 110, or advertising campaign, performs well. Preferably, the high performing websites 140 have been selected, as discussed above. Preferably, N is large enough so as to obtain a reliable sampling. Preferably, N is at least 5, and more preferably at least 10, and more preferably at least 20, and more preferably at least 50. An advertising campaign may have a number of similar, but not exactly the same, advertisements 110 which all relate to a single theme, company, or product.

Moving to block 204, upon compiling a list of N number of existing high performing websites 140, search results 120 are obtained either by performing a search query 122 for prominent keywords 124 in each high performing website 140 from the list of N number of existing high performing websites 140 using a first internet search engine or by reviewing a second internet search engine's search logs. Prominent keywords 124 are words from a high performing website 100 which help to describe or identify the high performing website 100 when performing a search query 122 on an internet search engine. Preferably, a list of prominent keywords 124 is either manually or automatically generated from each high performing website 100 either by manually reviewing the website 100 or by using an algorithm to automatically review the website 100 and generate a list of prominent keywords 124.

Preferably, each prominent keyword 124 or a derivation of that prominent keyword 124 is used alone, or in combination with other prominent keywords 124 or derivations of that or other prominent keywords 124, as a term or terms within a search query 119 on an internet search engine. Then, preferably, a search query 119 is performed for at least one prominent keyword 124 or a combination of prominent keywords 124, or their derivations, and preferably L number of prominent keywords 124 and combinations, and more preferably each prominent keyword 124 or combinations thereof generated using an internet search engine in order to generate search results 118 from each prominent keyword 124.

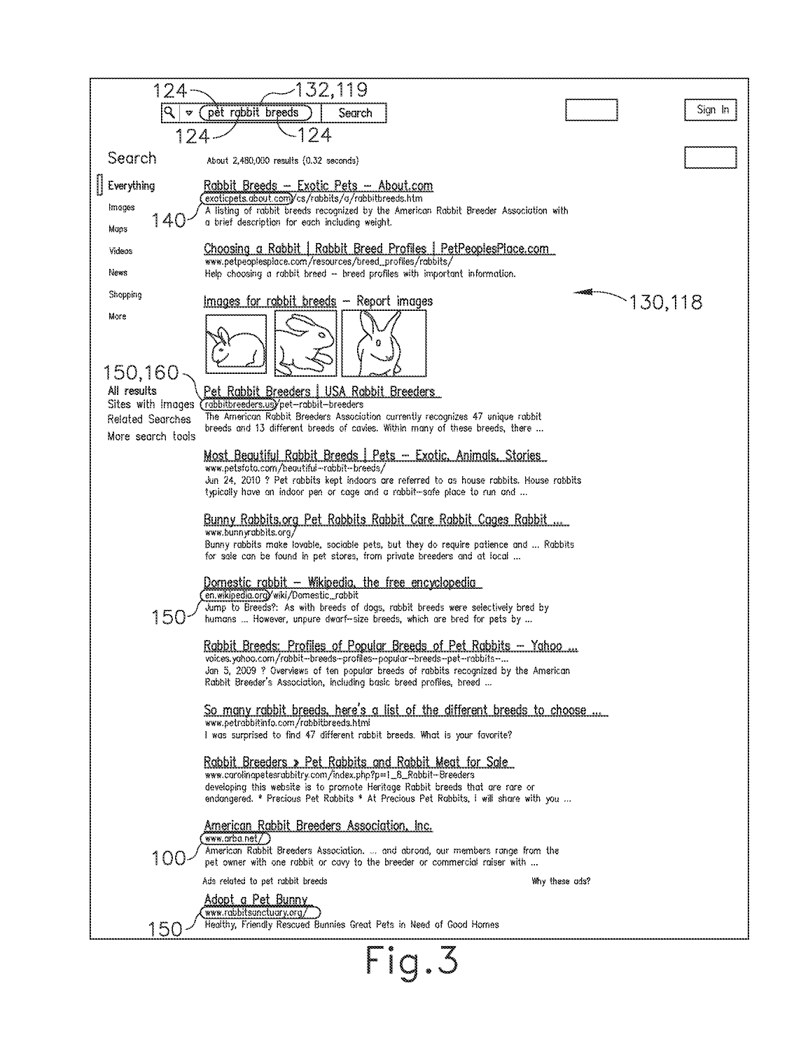

Upon performing the search query 119, a search result 118 is obtained which lists a number of websites 140 or webpages 142, as shown in FIGS. 2 and 3. Preferably L number search queries 119, such as a first search query 122 and a second search query 132, obtaining L number of search results 118, such as a first search result 120 and a second search result 130, are performed using a single or a combination of prominent keywords 124, or their derivations, as terms within the search queries 119. Preferably, L is large enough so as to obtain a reliable number of search results 118. Preferably, L is at least 5, and more preferably at least 10, and more preferably at least 20, and more preferably at least 50. Upon performing L number of search queries 119 using a single or a combination of prominent keywords 124, or their derivations, L number of search results 118 is obtained. Preferably, any search results 118 obtained by performing search queries 119 using a single or a combination of prominent keywords 124, or their derivations, which list a high performing website or websites 100 are flagged as being of particular relevance and set aside for further review, as shown in FIGS. 2 and 3.

In one embodiment, search results 120 are obtained by reviewing an interne search engine's search logs. An interne search engine typically retains a record of search queries 119 conducted by users of that interne search engine along with any search results 118 obtained by those search queries 119. As a result, by reviewing an interne search engine's search logs, search results 118 can be found as well. Search results 118 typically provide a listing of websites 140 or webpages 142 which are particularly relevant to a particular search query 119. Preferably, in reviewing an interne search engine's search logs, the search results 118 which list a high performing website or websites 100 are flagged as being of particular relevance and set aside for further review.

Moving to block 206, upon obtaining search results 118, and preferably, upon flagging any search results 118 found which list a high performing website or websites 100, a list of websites 140 which appear together along with any existing high performing website 100 in the obtained search results 118, is compiled.

Preferably, the compiling of a list of websites 140 which appear together along with any existing high performing website 100, includes only compiling websites 140 which appear together along with an existing high performing website 100 within a first M number of websites 140, or webpages 142 each of which are associated with a website 140, listed in a search result 118. Preferably, M is less than 100, and preferably less than 50, and preferably less than 20, and preferably less than 10. Preferably, any website 140 which appears together with an existing high performing website 100 is a give within the first M number of websites 140 listed in a search result 118 and does this again for a statistically significant number of search results 118, is flagged as a statistically significant website 150.

For example, with reference to FIGS. 2 and 3, in the first search results 120 a high performing website 100, “www.arba.net,” is the second website 140 listed in the search results 120 and a website 140, “rabbitbreeders.us” is the eight website 140 listed in the search results 120. In the second search results 130, the high performing website 100, “www.arba.net,” is the tenth website 140 listed in the search results 130 and the website 140, “rabbitbreeders.us” is the third website 140 listed in the search results 130. Since the website 140, “rabbitbreeders.us,” appears together along with the high performing website 100, “www.arba.net,” both of which appear within a first M number of websites 140 listed in a search result 118, in this case the first 10 websites, for at least two search results, search results 120 and 130, and assuming two search results is a statistically significant number of search results 118, then the website 140, “rabbitbreeders.us,” would be deemed a statistically significant website 150. Preferably, a statistically significant number of search results 118 is at least two, and preferably, at least 10, and preferably, at least 20 search results 118.

Moving to block 210, upon flagging websites 140 as a statistically significant websites 150, a co-occurrence rate is determined for each statistically significant website 150 and each existing high performing website 100. The co-occurrence rate is defined as the amount of times a statistically significant website 150 appears with an existing high performing website 100 in a statistically significant manner. A statistically significant website 150 appears with a particular existing high performing website 100 in a statistically significant manner when that website 150 appears within a first M number of websites 140, or webpages 142 each of which are associated with a website 140, listed in a search result 118, and when that website 150 does so with that particular existing high performing website 100 for a statistically significant number of search results 118.

For example, if a website 140, such as “rabbitbreeders.us,” appears with a first high performing website 100, “www.arba.net,” within a first M number of websites 140 listed in a search result 118, and does this for, a statistically significant number of search results 118, then that website is deemed a statistically significant website 150 which appears with 100 the first high performing website 100, “www.arba.net,” in a statistically significant manner. If the website 140, “rabbitbreeders.us,” also appears with only two other high performing websites 100 in in a statistically significant manner, and there are a total of N=4 number of existing high performing websites 100 (i.e. the compiled list of N number of existing high performing websites 100 has only N=4 high performing websites 100), then the co-occurrence rate in which the website 140, “rabbitbreeders.us,” appears with an existing high performing website 100 in a statistically significant manner is 3 out of 4, or 75% of existing high performing websites 100.

Moving to block 212, if the co-occurrence rate for a statistically significant website 150 is equal to or greater than a predetermined percentage of existing high performing websites 100, then the statistically significant website 150 is designated as a potential high performing website 160. Preferably, the predetermined percentage is at least 20%, and preferably at least 40%, and preferably at least 60%, and preferably at least 80%.

A potential high performing website 160 is a website 140 which is flagged as having the potential to be a high performing website 160. Preferably, any advertisement 110 from an advertisements campaign which is currently on a high performing website 160 is also suggested to be run on, or actually run, or placed on any potential high performing website 160 in order to increase the success of an advertisement campaign and the effectiveness of an advertisement, and in order to increase the quality of an ad or advertisement network which runs such advertisements 110. Preferably, the ad network upon which the advertisements are run on finds potential high performing websites 160 and presents them to users of the ad network, such as advertisers, in order to increase the quality of the ad network.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a non-transitory computer-readable storage medium having computer readable code stored thereon for programming a computer (e.g., comprising a processor) to perform a method as described and claimed herein. Examples of such non-transitory computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for identifying a website for placement of an advertisement comprising:
compiling, by one or more processors, a number, N, of existing websites that generate a positive return on investment for a preselected advertisement;
retrieving, by the one or more processors, a plurality of stored search results from a search results database, wherein the search results are generated by an internet search engine and each of the search results comprises at least one of the N existing websites that generate a positive return on investment;
identifying, by the one or more processors, websites that appear in a statistically significant number of the search results;
calculating, by the one or more processors, a co-occurrence rate for each of the identified websites based on a number of the search results that include both the identified website and any of the existing N websites;
adding, by the one or more processors, an identified website to the number, N, of existing websites when the co-occurrence rate for the identified website and any of the N existing websites is equal to or greater than a predetermined percentage of the N websites; and
placing, by the one or more processors, an advertisement on the identified website via an internet advertising network, wherein the advertisement is selected from a group of advertisements placed on any of the existing N websites.

2. The method of claim 1, wherein each of the N existing websites has a lower cost per action than a predetermined amount.

3. The method of claim 1, wherein identifying the websites comprises identifying websites that appear together along with any of the N existing websites within a first M number of websites listed in a search result, wherein M is less than 100, and wherein any website, that appears together with any of the N existing websites within the first M number of websites listed in a search result and for a statistically significant number of search results, is flagged as a statistically significant website.

4. The method of claim 1 further comprising placing an advertisement from an advertisement campaign which is currently on any of the existing N websites on the identified website.

5. The method of claim 1, wherein the predetermined percentage of the N existing websites is at least 60%.

6. The method of claim 1, wherein N is at least ten.

7. A method for identifying a website for placement of an advertisement comprising:
compiling, by one or more processors, a number, N, of existing websites that generate a positive return on investment for a preselected advertisement;
generating, by the one or more processors, keywords from each of the N websites;
using an internet search engine to perform, by the one or more processors, a search and generate a search result for each generated keyword, each of the search results comprising at least one of the N existing websites that generate a positive return on investment;
identifying, by the one or more processors, websites that appear in a statistically significant number of the search results;
calculating, by the one or more processors, a co-occurrence rate for each of the identified websites based on a number of the search results that include both the identified website and any of the existing N websites;
adding, by the one or more processors, an identified website to the number, N, of existing websites when the co-occurrence rate for the identified website and any of the N existing websites is equal to or greater than a predetermined percentage of the N websites and
placing, by the one or more processors, an advertisement on the identified website via an internet advertising network, wherein the advertisement is selected from a group of advertisements placed on any of the existing N websites.

8. The method of claim 7, wherein each of the N existing websites has a lower cost per action than a predetermined amount.

9. The method of claim 7, wherein identifying the websites comprises identifying websites that appear together along with any of the N websites within a first M number of websites listed in a search result, wherein M is less than 100.

10. The method of claim 9, wherein any website, that appears together with any of the N existing websites within the first M number of websites listed in a search result and for a statistically significant number of results, is flagged as a statistically significant website.

11. The method of claim 7 further comprising placing an advertisement from an advertisement campaign which is currently on any of the existing N websites on the identified website.

12. The method of claim 7, wherein the predetermined percentage of the N existing websites is at least 60%.

13. The method of claim 7, wherein N is at least ten.

14. A non-transitory computer-readable medium that stores instructions executable by one or more processors to perform a method for identifying a website for placement of an advertisement, comprising:
instructions for compiling a number, N, of existing websites that generate a positive return on investment for a preselected advertisement;
instructions for retrieving a plurality of stored search results from a search results database, wherein the search results are generated by an internet search engine and each of the search results comprises at least one of the N existing websites that generate a positive return on investment;
instructions for identifying websites that appear in a statistically significant number of search results;
instructions for calculating a co-occurrence rate for each of the identified websites based on a number of the search results that include both the identified website and any of the existing N websites;
instructions for adding an identified website to the number, N, of existing websites when a co-occurrence rate for the identified website and one of the N existing websites is equal to or greater than a predetermined percentage of the N websites; and
instructions for placing an advertisement on the identified website via an internet advertising network, wherein the advertisement is selected from a group of advertisements placed on any of the existing N websites.

15. The computer-readable medium of claim 14 further comprising instructions for obtaining search results either by performing a search query for keywords in each website using a first internet search engine or by reviewing a second internet search engine's search logs.

16. The computer-readable medium of claim 14, wherein each of the N existing websites has a lower cost per action than a predetermined amount.

17. The computer-readable medium of claim 14, wherein the instructions for identifying the websites comprises identifying websites that appear together along with any of the N websites within a first M number of websites listed in a search result, wherein M is less than 100.

18. The computer-readable medium of claim 14 further comprising instructions for placing an advertisement from an advertisement campaign which is currently on any of the existing N websites on the identified website.

19. The computer-readable medium of claim 14, wherein the predetermined percentage of the N existing websites is at least 60%.

20. The computer-readable medium of claim 14, wherein N is at least ten.
